(19) United States
(12) Patent Application Publication
(10) Pub. No.: US 2026/0231879 A1
(43) Pub. Date: Aug. 13, 2026

(54) IRRIGATION EMITTER

(71) Applicant: The Toro Company, Bloomington, MN (US)

(72) Inventor: Luis R. Niquet, Temecula, CA (US)

(73) Assignee: The Toro Company, Bloomington, MN (US)

(21) Appl. No.: 19/470,964

(22) PCT Filed: May 3, 2024
(86) PCT No.: PCT/US2024/027623

§ 371 Date: Sep. 30, 2025

Related U.S. Application Data
(60) Provisional application No. 63/469,235, filed on May 26, 2023.

(51) Int. Cl. A01G 25/02

(52) U.S. Cl. CPC A01G 25/023; A01G 25/026

(57) ABSTRACT

An emitter includes a base having a top, a bottom, a first end, a second end, a first side, and a second side. The base includes a pressure reducing portion. The top includes an inlet receiver in communication with a first portion of the pressure reducing portion. The bottom includes an outlet bore in communication with a last portion of the pressure reducing portion. At least one intermediate portion interconnects the first and last portions, and portions of the pressure reducing portion are in communication in series between the inlet receiver and the outlet bore to form a portion of an irrigation flow path. Each portion of the pressure reducing portion includes a first path portion with a first diameter and a second path portion with a second diameter, which is different than the first diameter to create a pressure loss when flowing through the pressure reducing portion.

### BACKGROUND

An irrigation emitter is operatively connected to a lateral to form an irrigation lateral, which is configured and arranged to supply irrigation water from the lateral's irrigation water passageway, through the emitter's irrigation water flow path, and through the lateral's outlet aperture to the lateral's external environment. Irrigation laterals are commonly used in agricultural irrigation where the irrigation water quality is poor. The emitters clog when small particles in the water get trapped in the inlet portions of the emitters or along the flow path, and the irrigation laterals become dysfunctional until they are flushed or replaced, which is time consuming. Therefore, it is desired to design an irrigation emitter that is compact and clog-resistant.

For the reasons stated above and for other reasons stated below, which will become apparent to those skilled in the art upon reading and understanding the present specification, there is a need in the art for an irrigation emitter that is compact and clog-resistant.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an emitter is configured and arranged for use with a lateral, which includes a lateral wall having an inner surface and an outlet aperture, to form an irrigation lateral. The emitter includes a base having a top, a bottom, a first end, a second end, a first side, and a second side. The base includes a pressure reducing portion. The top includes an inlet receiver in fluid communication with a first portion of the pressure reducing portion. The bottom includes an outlet bore in fluid communication with a last portion of the pressure reducing portion and the outlet aperture. At least one intermediate portion interconnects the first portion and the last portion, and portions of the pressure reducing portion are in fluid communication in series between the inlet receiver and the outlet bore to form a portion of an irrigation flow path. Each portion of the pressure reducing portion includes a first path portion with a first diameter and a second path portion with a second diameter, which is different than the first diameter to create a pressure loss when flowing through the pressure reducing portion. The bottom is configured and arranged to operatively connect to the inner surface of the lateral wall.

In one embodiment, an emitter is configured and arranged for use with a lateral, which includes a lateral wall having an inner surface and an outlet aperture, to form an irrigation lateral. The emitter includes a base having a top, a bottom, a first end, a second end, a first side, and a second side. The base includes a pressure reducing portion. The top includes an inlet receiver in fluid communication with a first portion of the pressure reducing portion. The bottom includes an outlet bore in fluid communication with a last portion of the pressure reducing portion and the outlet aperture. At least a first intermediate portion interconnects the first portion and the last portion, and portions of the pressure reducing portion are in fluid communication in series between the inlet receiver and the outlet bore to form a portion of an irrigation flow path. The first intermediate portion includes a first vertical path portion interconnecting a first top path portion and a first bottom path portion. The first vertical path portion has a first vertical diameter, the first top path portion has a first top diameter, and the first bottom path portion has a first bottom diameter. The first vertical diameter is smaller than the first top diameter and smaller than the first bottom diameter to create a first pressure loss when flowing through the pressure reducing portion. The bottom is configured and arranged to operatively connect to the inner surface of the lateral wall.

In one embodiment, a combination emitter and lateral form an irrigation lateral. The lateral includes a lateral wall having an inner surface and an outlet aperture. The emitter includes a base having a top, a bottom, a first end, a second end, a first side, and a second side. The base includes a pressure reducing portion. The top includes an inlet receiver in fluid communication with a first portion of the pressure reducing portion. The bottom includes an outlet bore in fluid communication with a last portion of the pressure reducing portion and the outlet aperture. At least one intermediate portion interconnects the first portion and the last portion, and portions of the pressure reducing portion are in fluid communication in series between the inlet receiver and the outlet bore to form a portion of an irrigation flow path. Each portion of the pressure reducing portion includes a first path portion with a first diameter and a second path portion with a second diameter, which is different than the first diameter to create a pressure loss when flowing through the pressure reducing portion. The bottom is configured and arranged to operatively connect to the inner surface of the lateral wall.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is an exploded top perspective view of an embodiment irrigation emitter constructed in accordance with the principles of the present invention;

FIG. 2 is a side assembled view of the irrigation emitter shown in FIG. 1;

FIG. 3 is a top view of the irrigation emitter shown in FIG. 2;

FIG. 4 is a cross section view of the irrigation emitter shown in FIG. 2 taken along the lines 4-4 in FIG. 3;

FIG. 5 is a magnified portion of the cross section view shown in FIG. 4;

FIG. 6 is a cross section view of the irrigation emitter shown in FIG. 2 taken along the lines 6-6 in FIG. 3;

FIG. 7 is a magnified portion of the cross section view shown in FIG. 6;

FIG. 8 is a bottom perspective view of a cover of the irrigation emitter shown in FIG. 1;

FIG. 9 is a top view of a base of the irrigation emitter shown in FIG. 1;

FIG. 10 is a cross section view of the irrigation emitter shown in FIG. 2 taken along the lines 10-10 in FIG. 9;

FIG. 11 is a magnified portion of the cross section view shown in FIG. 10;

FIG. 12 is a bottom perspective view of the base shown in FIG. 9;

FIG. 13 is a bottom view of the base shown in FIG. 9;

FIG. 14 is a bottom view of the base shown in FIG. 9 with the top view superimposed thereon;

FIG. 15 is a first side perspective cross section view of the base shown in FIG. 9 taken along the lines 15-15 in FIG. 14;

FIG. 16 is a second side perspective cross section view of the base shown in FIG. 9 taken along the lines 15-15 in FIG. 14;

FIG. 17A is a perspective view of the base shown in FIG. 9 operatively connected to a lateral to form an irrigation lateral;

FIG. 17B is a perspective view of the base shown in FIG. 9 operatively connected to a lateral with an outlet aperture to form an irrigation lateral;

FIG. 18 illustrates dimensions of an embodiment tube for use with the irrigation emitter shown in FIG. 1;

FIG. 19 is a graph illustrating flow rate versus Reynolds values for different tube shapes;

FIG. 20 is a graph illustrating k values as functions of flow area ratios; and

FIG. 21 is a top view of a base of an embodiment irrigation emitter.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide irrigation emitters including pressure reducing portions having adjacent vertical path portions interconnected with horizontal path portions, which forms a flow path interconnecting inlet and outlet sections. The vertical path portions and the horizontal path portions have different diameters thereby creating pressure losses when flowing through the pressure reducing portions. The configuration of the flow path through a pressure reducing portion allows for a more compact emitter that is clog-resistant.

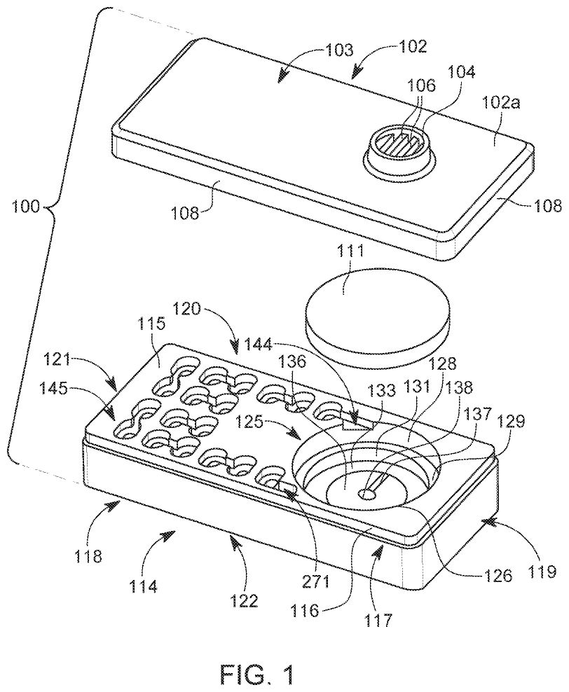

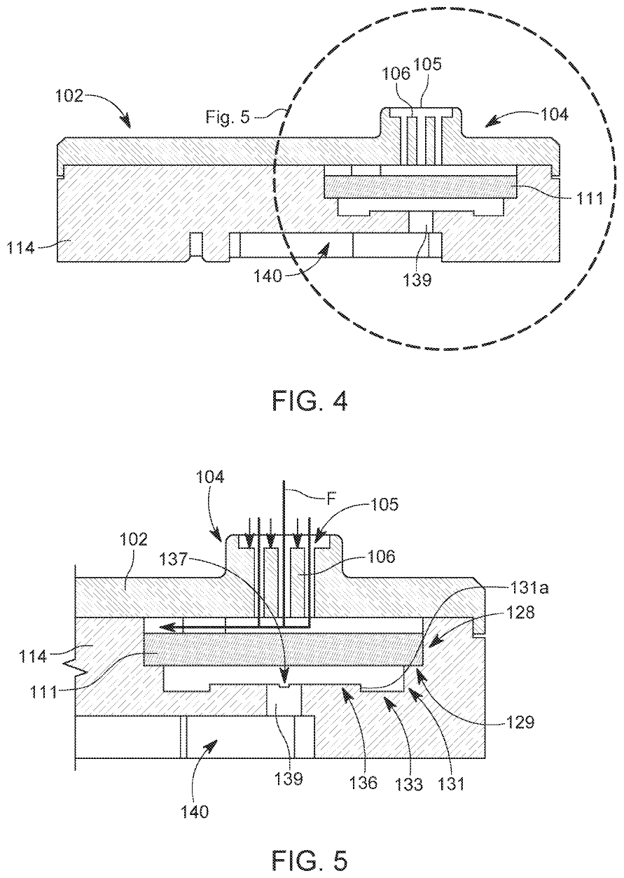

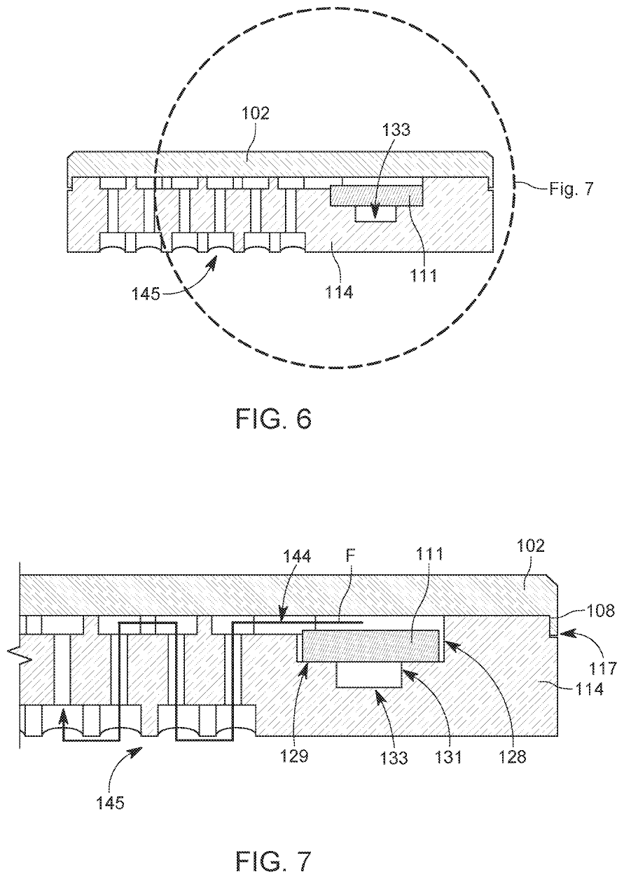

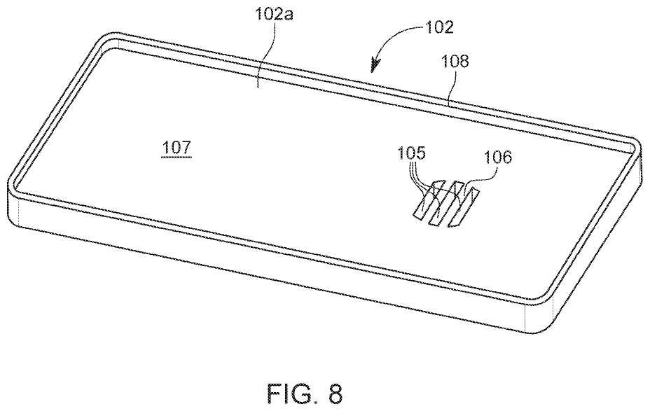

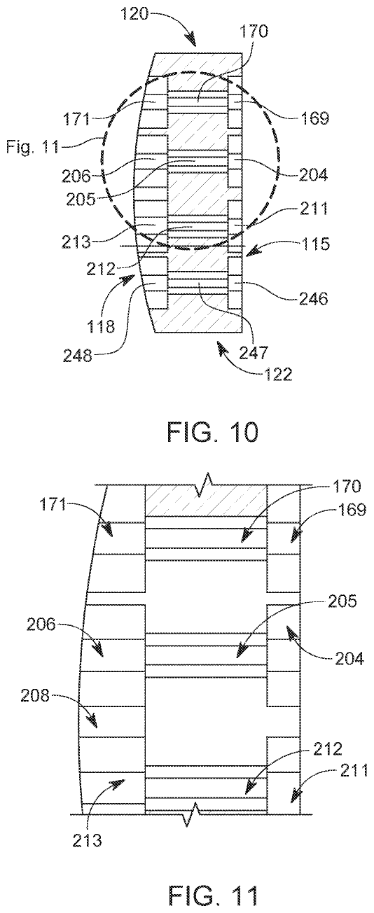

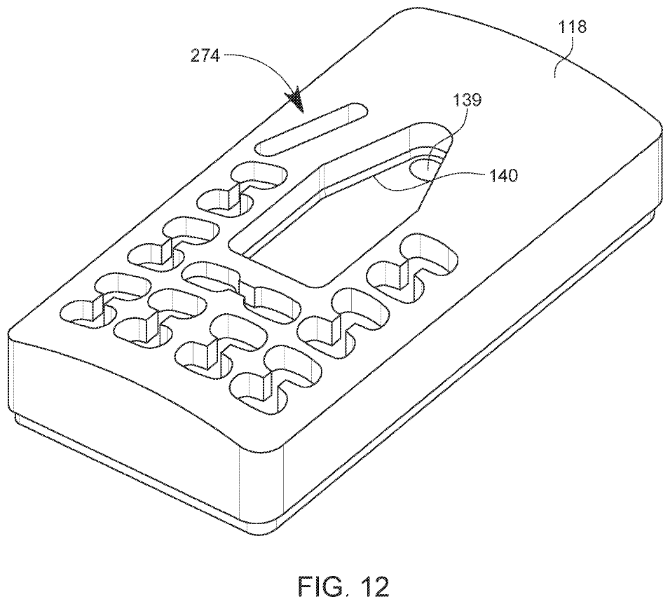

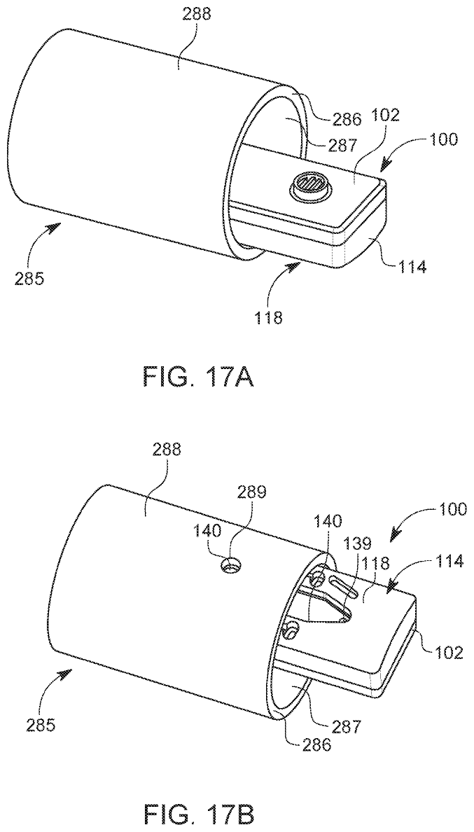

In one embodiment, illustrated in FIGS. 1-17, an emitter 100 includes a cover 102, a diaphragm 111, and a base 114. The cover 102 includes a generally rectangular plate 102a having a top 103 and a bottom 107 with a flange 108 extending downward from its perimeter. An inlet 104 extends upward from the top 103. Preferably, the inlet 104 is cylindrical with filter members 106 extending across the inlet aperture 105 formed in the plate 102a and the inlet 104.

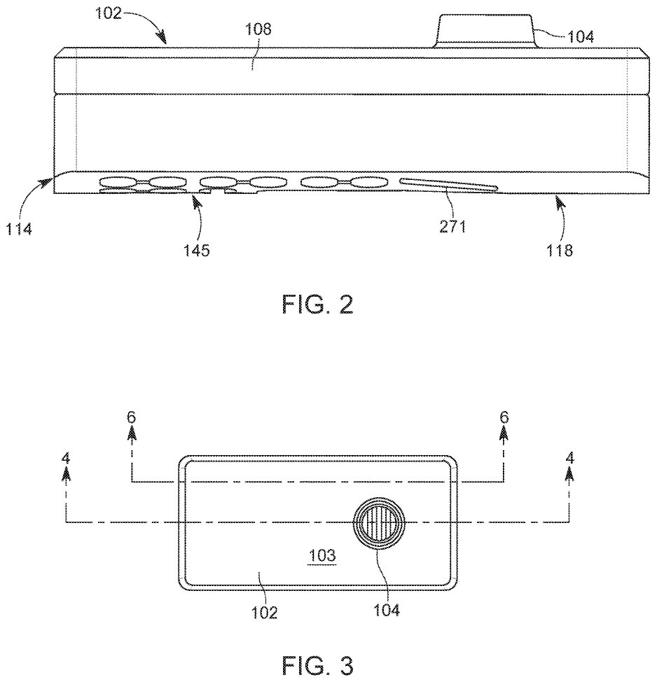

The base 114 is generally rectangular with a top 115 slightly smaller than a bottom 118. The top 115 includes a top edge 116 inset from the bottom 118 to form a ledge 117. The top edge 116 is configured and arranged to have a friction fit with the cover's flange 108, which contacts the ledge 117 and is preferably flush with the bottom, as shown in FIG. 2. These are preferably laser welded during assembly. The base 114 has a first end 119, a first side 120, a second end 121, and a second side 122.

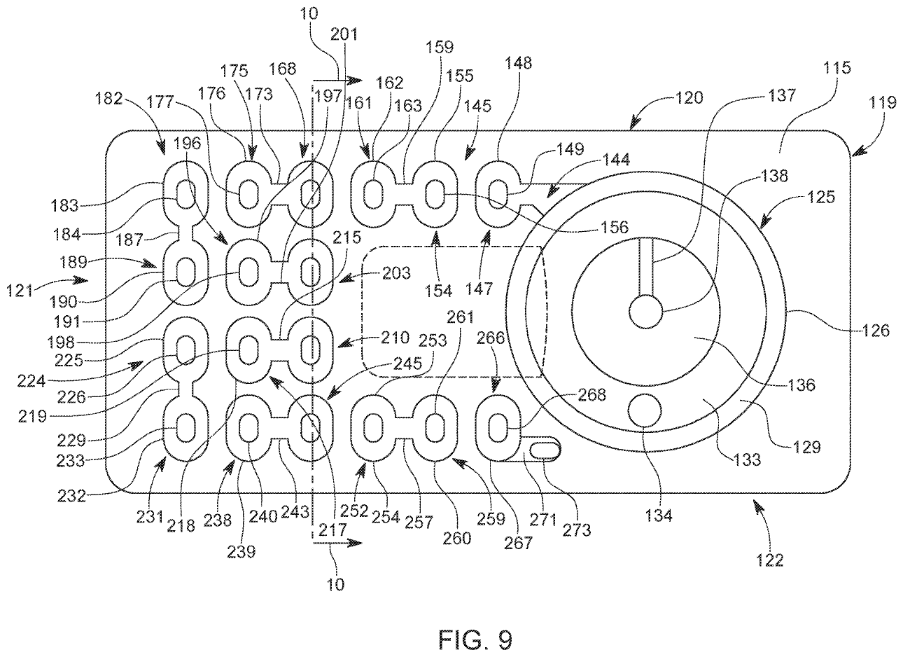

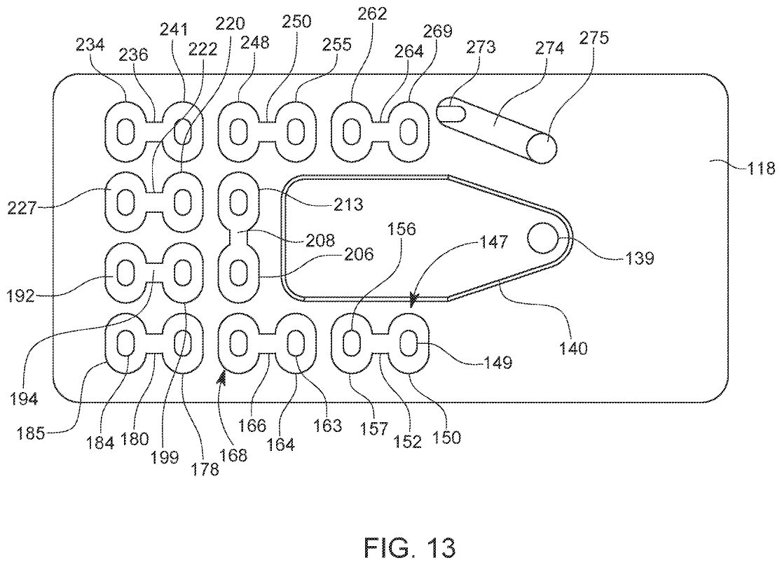

Proximate the first end 119, the base 114 includes a weir 125 having an opening 126. The weir 125 has an upper side wall 128 that has a larger diameter than a lower side wall 131 thereby forming an upper ledge 129 proximate the juncture between the side walls 128 and 131. As shown in FIG. 5, a lower ledge 133 interconnects the lower side wall 131 and a bottom 136, which is raised slightly from the lower ledge 133 to form an inner side wall 131a. A land height is a distance between the upper ledge 129 upon which the diaphragm 111 rests and the bottom 136. Preferably, in this example as shown in FIG. 5, the land height is less than 1.2 mm, preferably approximately 0.024+/−0.010 inch (0.6+/−0.25 mm). As shown in FIG. 9, the lower ledge 133 includes a bore 134, and the bottom 136 includes a channel 137 extending from the lower ledge 133 to an outlet bore 138 proximate the center of the bottom 136. The outlet bore 138 extends through the base 114 and there is an outlet opening 139 that is in fluid communication with an outlet cavity 140 formed in the bottom 118 of the base 114, as shown in FIG. 13. The diaphragm 111 is configured and arranged to fit within the upper side wall 128 on the upper ledge 129, and the diaphragm 111 is configured and arranged to deflect within the weir 125 in response to water pressure. Preferably, the diaphragm 111 is made of silicone but any suitable material can be used. Although the inlet 104 and the outlet bore 138 are in fluid communication in the base 114, the diaphragm 111 acts as a divider to prevent water from flowing from the inlet 104 to the outlet bore 138. Instead, the diaphragm 111 directs water from the inlet 104 to an inlet receiver 144 proximate the top of the weir 125.

The inlet receiver 144 extends from the upper side wall 128 proximate the first side 120 of the base 114 and interconnects the weir 125 and the pressure reducing portion 145. The pressure reducing portion 145 generally includes a series of slot-tube assemblies configured and arranged to direct water through horizontal path portions and vertical path portions relative to the base 114. The horizontal path portions generally extend longitudinally and laterally proximate the top and bottom of the base 114 and have first diameters. The vertical path portions generally interconnect opposing (from top to bottom) horizontal path portions and have second diameters. In this embodiment, the second diameters are smaller than the first diameters. Preferably, the second diameters are generally oval in cross section (generally rectangular with rounded ends). The slot-tube assemblies are best shown in FIGS. 9-11 and 13. In this example, the vertical path portions are preferably 0.020+/−0.010 inch by 0.081+/−0.010 inch with corners having radii of 0.020+/−0.010 and are preferably 0.118+/−0.010 inch long. The horizontal portions are preferably 0.020+/−0.010 inch long, 0.022+/−0.010 inch wide, and 0.027+/−0.010 inch deep.

As best shown in FIGS. 9 and 13, the inlet receiver 144 is in fluid communication with a first portion 147. The first portion 147 includes a top slot 148, a vertical tube 149, and a bottom slot 150. A horizontal tube 152 interconnects the bottom slot 150 and a bottom slot 157 of a second portion 154. The second portion 154 includes a top slot 155, a vertical tube 156, and the bottom slot 157. A horizontal tube 159 interconnects the top slot 155 and a top slot 162 of a third portion 161. The third portion 161 includes the top slot 162, a vertical tube 163, and a bottom slot 164. A horizontal tube 166 interconnects the bottom slot 164 and a bottom slot 171 of a fourth portion 168. The fourth 168 portion includes a top slot 169, a vertical tube 170, and the bottom slot 171. A horizontal tube 173 interconnects the top slot 169 and a top slot 176 of a fifth portion 175. The fifth portion 175 includes the top slot 176, a vertical tube 177, and a bottom slot 178. A horizontal tube 180 interconnects the bottom slot 178 and a bottom slot 185 of a sixth portion 182. The sixth portion 182 includes a top slot 183, a vertical tube 184, and the bottom slot 185. A lateral tube 187 interconnects the top slot 183 and a top slot 190 of a seventh portion 189. The seventh portion 189 includes the top slot 190, a vertical tube 191, and a bottom slot 192. A horizontal tube 194 interconnects the bottom slot 192 and a bottom slot 199 of an eighth portion 196. The eighth portion 196 includes a top slot 197, a vertical tube 198, and the bottom slot 199. A horizontal tube 201 interconnects the top slot 197 and a top slot 204 of a ninth portion 203. The ninth portion 203 includes the top slot 204, a vertical tube 205, and a bottom slot 206. A lateral tube 208 interconnects the bottom slot 206 and a bottom slot 213 of a tenth portion 210. The tenth portion 210 includes a top slot 211, a vertical tube 212, and the bottom slot 213. A horizontal tube 215 interconnects the top slot 211 and a top slot 218 of an eleventh portion 217. The eleventh portion 217 includes the top slot 218, a vertical tube 219, and a bottom slot 220. A horizontal tube 222 interconnects the bottom slot 220 and a bottom slot 227 of a twelfth portion 224. The twelfth portion 224 includes a top slot 225, a vertical tube 226, and the bottom slot 227. A lateral tube 229 interconnects the top slot 225 and a top slot 232 of a thirteenth portion 231. The thirteenth portion 231 includes the top slot 232, a vertical tube 233, and a bottom slot 234. A horizontal tube 236 interconnects the bottom slot 234 and a bottom slot 241 of a fourteenth portion 238. The fourteenth portion 238 includes a top slot 239, a vertical tube 240, and the bottom slot 241. A horizontal tube 243 interconnects the top slot 239 and a top slot 246 of a fifteenth portion 245. The fifteenth portion 245 includes the top slot 246, a vertical tube 247, and a bottom slot 248. A horizontal tube 250 interconnects the bottom slot 248 and a bottom slot 255 of a sixteenth portion 252. The sixteenth portion 252 includes a top slot 253, a vertical tube 254, and the bottom slot 255. A horizontal tube 257 interconnects the top slot 253 and a top slot 260 of a seventeenth portion 259. The seventeenth portion 259 includes the top slot 260, a vertical tube 261, and a bottom slot 262. A horizontal tube 264 interconnects the bottom slot 262 to a bottom slot 269 of an eighteenth portion 266. The eighteenth portion 266 includes a top slot 267, a vertical tube 268, and the bottom slot 269. A horizontal tube 271 interconnects the top slot 267 to a first bore opening 273. The first bore opening 273 is proximate the top of the base 114, a second bore opening 275 is proximate the bottom of the base 114, and a bore 274 extends therebetween. Generally, the horizontal tubes and their respective slots form the horizontal path portions and the vertical tubes form the vertical path portions.

The bottom 118 of the base 114 is configured and arranged to be operatively connected to a lateral 285. The lateral 285 includes a wall 286 with an inner surface 287, an outer surface 288, and an outlet aperture 289 extending through the wall 286. In this embodiment, a portion of the lateral's inner surface 287 to which the base 114 is connected forms part of the water flow path F, with the outlet opening 139 and the outlet cavity 140 being in fluid communication with the outlet aperture 289. In addition, in this embodiment, the cover 102 also forms part of the water flow path F. Because the top and bottom slots are open and the lateral and the cover form part of the water flow path F, the base 114 includes less material.

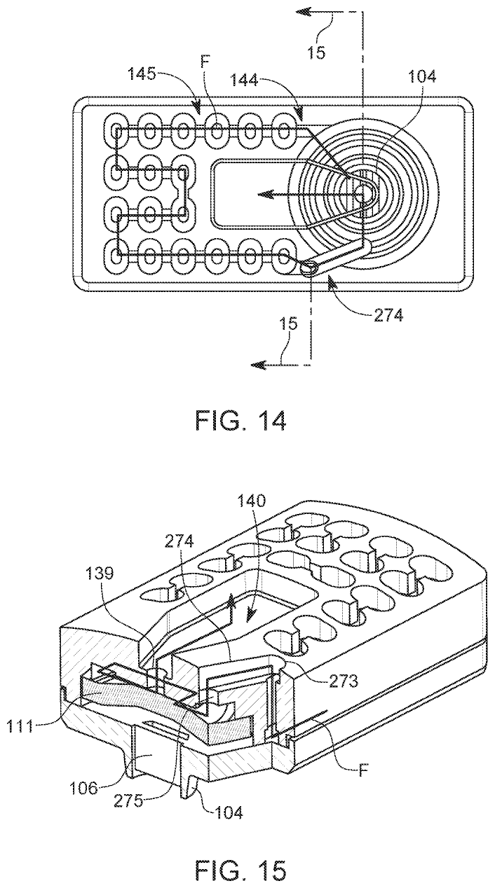

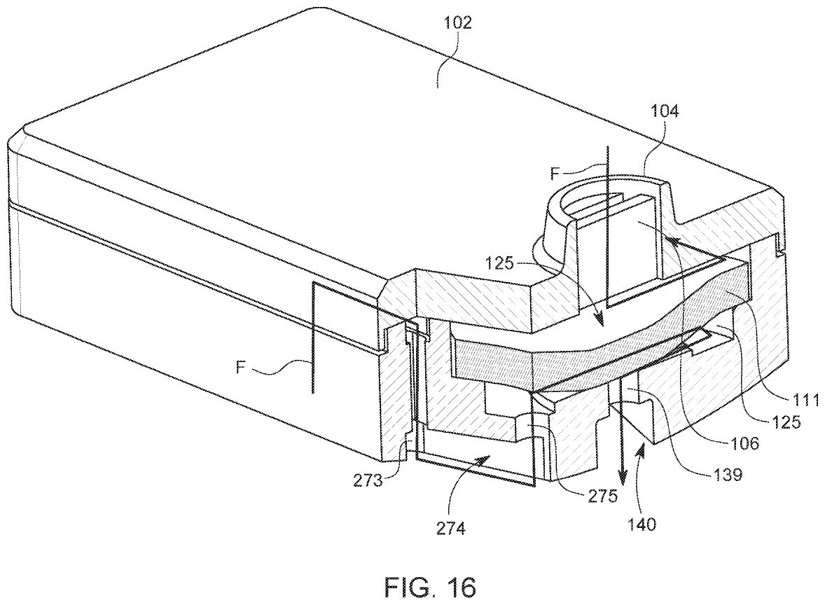

In operation, a portion of irrigation water flowing through the lateral 285 enters the inlet 104 and then flows through the emitter 100, as shown in FIGS. 5, 7, and 14-16. Preferably, the working range of the emitter is 5 to 60 psi. The filter members 106 assist in preventing larger debris from entering the inlet 104. Generally, the emitter flow path F is shown with arrows in these figures. Although not illustrated in all of the figures, as shown in FIG. 16, as the irrigation water flows from the inlet 104 into the weir 125 above the diaphragm 111, the diaphragm 111 deflects in the weir cavity right before discharging to atmosphere when incoming pressure from the inlet ensues. The diaphragm 111 deflects downward toward the bottom 136 and the irrigation water flows into the inlet receiver 144 where it then flows through the pressure reducing portion 145 as generally illustrated in FIG. 14. The irrigation water then flows from the first portion's top slot 148, through the tube 149, through the bottom slot 150 (with one of the top or bottom slots being a first path portion, the tube being a second path portion, and the other of the top or bottom slots being a third path portion in this embodiment), through the other portions interconnected with connecting portions as previously described, and then from the eighteenth (last) portion's top slot 267 through the tube 271, through the first bore opening 273, through the bore 274, through the second bore opening 275, and through bore 134 into the weir 125 below the diaphragm 111. When the diaphragm 111 is deflected downward, the irrigation water can only go through the channel 137 to the outlet bore 138, where it then goes through the outlet opening 139 into the outlet cavity 140. As it goes through the channel 137, the pressure is reduced drastically to match the nominal flow rate at different pressure points. As pressure increases, the diaphragm 111 deflects further downward on top of the channel 137 thereby extending the length of the “working channel”, which means the channel becomes longer as the pressure increases thus increasing the water flow resistance. The more resistance, the more pressure burning effect on the final flow rate. This behavior keeps the flow rate constant due to larger incoming pressure loads on the diaphragm 111. From the outlet cavity 140, the irrigation water flows through the outlet aperture 289.

As the irrigation water flows through the pressure reducing portion, the sudden change in diameter from smaller to larger diameters (from first path portions (vertical tubes in this embodiment) to second path portions (top or bottom slots in this embodiment)) causes pressure losses. Pressure losses are repeated as the irrigation water flows through each portion. The horizontal and lateral tubes interconnect adjacent top slots and bottom slots as shown in FIGS. 9 and 13. Because the water flow path is longitudinal, lateral, and vertical relative to the base, without dead zones (zones where low to zero velocity is found and where grit can stagnate to create clogging), and because of the repeated pressure losses throughout the flow path, the emitter is more compact and clog-resistant than prior emitters.

### Example 1

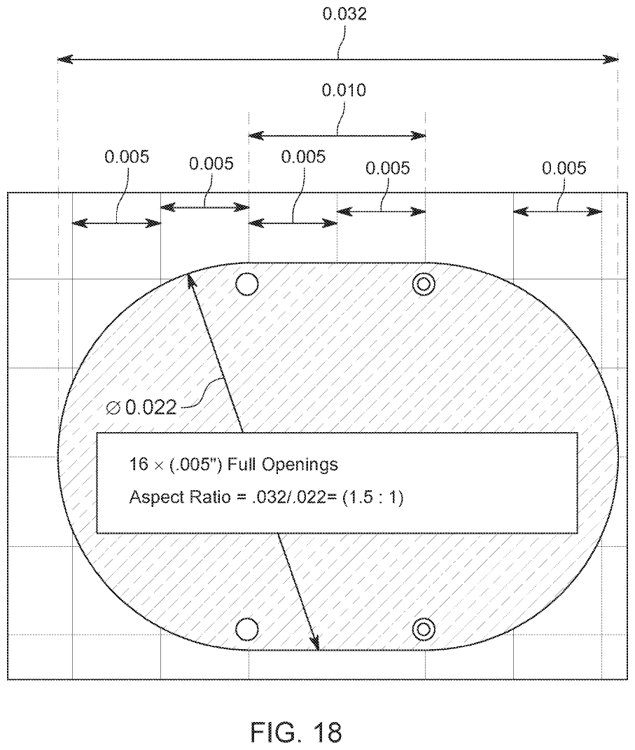

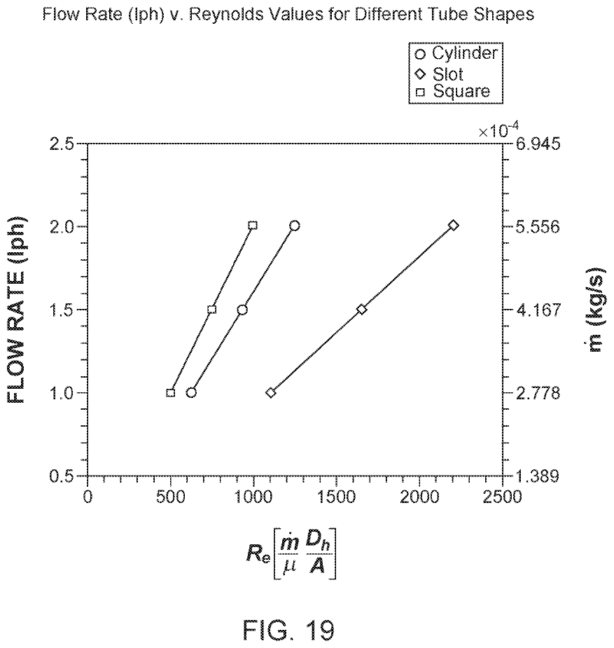

The vertical tube shape and size was investigated. Tube shapes sized with approximately 0.028 inch diameters were tested. The tube shapes were a cylinder, a slot (rectangle with rounded edges), and square with rounded edges. The test results are shown in FIG. 19, and the higher Reynolds numbers mean better pressure losses. From these results, it was determined that the slot shape is better in viscous losses than the cylinder or square shapes. As shown in FIG. 18, an embodiment tube shape is a slot shape with 16×(0.005″) full openings and an aspect ratio of 0.032/0.022=(1.5:1). It was determined that pressure loss through a rectangular duct is higher than a volumetrically equal cylindrical duct, and the higher the aspect ratio, the higher the pressure loss in rectangular systems.

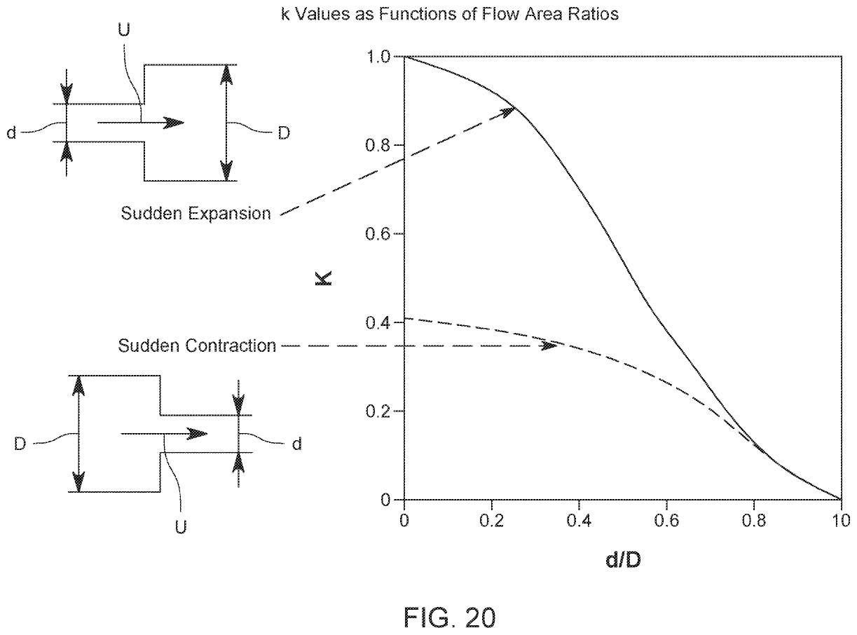

As shown in FIG. 20, the (k) values are resistance coefficients as functions of flow area ratios. The sudden expansion in red implies a larger deceleration of flow which induces more viscous loss than a contraction which conversely implies a required acceleration in contraction to create the pressure loss in expansion. Deceleration and acceleration work hand in hand. Deceleration tends to promote transition from laminar to turbulent flow to enhance viscous effects. Another beneficial characteristic is that all sudden changes in areas in flow tend to promote separation which creates additional pressure losses.

Preferably, the base has a length of less than 1.0 inch. In one example embodiment, the emitter includes the following dimensions:

| Feature | Dimensions (inch) |
|---|---|
| Cover | Length 0.894 +/− 0.002 |
| | Width 0.435 +/− 0.002 |
| | Height 0.050 +/− 0.005 |
| Inlet | Diameter 0.075 +/− 0.005 |
| Base | Length 0.894 +/− 0.002 |
| | Width 0.435 +/− 0.002 |
| | Height 0.300 +/− 0.005 |
| Pressure Reducing | Length 0.170 +/− 0.002 |
| Portion | Width 0.363 +/− 0.002 |
| Weir | Opening/Upper Side Wall Diameter 0.343 +/− 0.003 |
| | Lower Side Wall Diameter 0.293 +/− 0.003 |
| | Bottom Diameter 0.183 +/− 0.003 |
| | Bore (Lower Ledge) Diameter 0.039 +/− 0.003 |
| | Outlet Opening Diameter 0.039 +/− 0.003 |
| Weir Channel | Length 0.073 +/− 0.002 |
| | Width 0.013 +/− 0.001 |
| | Height 0.025 +/− 0.002 |
| Top Slot | Length 0.081 +/− 0.001 |
| | Width 0.055 +/− 0.002 |
| | Diameter 0.055 +/− 0.001 |
| | Height 0.027 +/− 0.001 |
| Vertical Tube | Length 0.035 +/− 0.001 |
| | Width 0.020 +/− 0.001 |
| | Diameter 0.020 +/− 0.002 |
| | Height 0.118 +/− 0.002 |
| Bottom Slot | Length 0.081 +/− 0.002 |
| | Width 0.055 +/− 0.002 |
| | Diameter 0.055 +/− 0.002 |
| | Height 0.025 +/− 0.001 |
| Horizontal Tube | Length 0.020 +/− 0.001 |
| | Width 0.022 +/− 0.002 |

Preferably, the emitter has a mesh limit of 120 to 40.

### Example 2

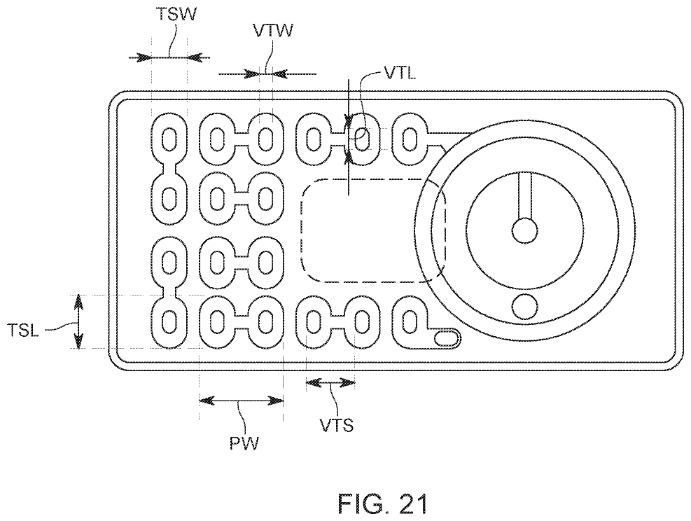

Another embodiment is illustrated in FIG. 21 and example dimensions are shown. Preferably, in this example, for each vertical tube, the vertical tube width VTW is 0.020+/−0.010 inch and the vertical tube length VTL is 0.035+/−0.010 inch. The vertical tube corners have radii of 0.020+/−0.010. The height of each vertical tube is 0.118+/−0.010 inch. For each top slot, the top slot width TSW is 0.055+/−0.010 inch and the top slot length TSL is 0.081+/−0.010 inch. The top slot corners have radii of 0.020+/−0.010. The height of each top slot is 0.027+/−0.010 inch. The portion width PW is 0.130+/−0.010 inch, and the vertical tube spacing VTS is 0.075+/−0.010 inch. Although not shown, the bottom slots are preferably similar to the top slots.

Advantages to embodiments include better self-cleaning, lower filtration requirements (improved grit resistance), increased clogging resistance, improved pressure reduction, reduced emitter size, and simplified molding and installation processes resulting in improved quality.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An emitter for use with a lateral to form an irrigation lateral, the lateral including a lateral wall having an inner surface and an outlet aperture, comprising:
a base having a top, a bottom, a first end, a second end, a first side, and a second side, the base including a pressure reducing portion, the top including an inlet receiver in fluid communication with a first portion of the pressure reducing portion, the bottom including an outlet bore in fluid communication with a last portion of the pressure reducing portion and the outlet aperture, at least one intermediate portion interconnecting the first portion and the last portion, the portions of the pressure reducing portion being in fluid communication in series between the inlet receiver and the outlet bore to form a portion of an irrigation flow path, each portion of the pressure reducing portion including a first path portion and a second path portion, the first path portion having a first diameter and the second path portion having a second diameter, the second diameter being different than the first diameter to create a pressure loss when flowing through the pressure reducing portion, the bottom configured and arranged to operatively connect to the inner surface of the lateral wall.

2. The emitter of claim 1, wherein the first path portion of each portion of the pressure reducing portion is positioned proximate one of the top or the bottom of the base and forms an opening in the respective top or bottom.

3. The emitter of claim 2, wherein the opening is in the top, further comprising a cover configured and arranged to engage the top of the base, the cover and the top forming part of the irrigation flow path, the cover including an inlet in fluid communication with the inlet receiver of the base.

4. The emitter of claim 2, wherein the first path portion is positioned proximate the top and forms a top opening, further comprising a third path portion positioned proximate the bottom forming a bottom opening, the third path portion having a third diameter, the second diameter being different than the third diameter to create a pressure loss when flowing through the pressure reducing portion, wherein the second path portion vertically interconnects the first and third path portions, wherein at least one of the first and third path portions is interconnected to an adjacent portion with a connecting portion.

5. The emitter of claim 4, wherein the second diameter is smaller than the first diameter and the third diameter.

6. The emitter of claim 4, further comprising a cover configured and arranged to engage the top of the base, wherein the cover and the lateral along with their respective first and third path portions form part of the irrigation flow path.

7. The emitter of claim 1, further comprising a diaphragm positioned between the inlet receiver and the outlet bore.

8. The emitter of claim 7, wherein the diaphragm is configured and arranged to deflect when water flows through an inlet in fluid communication with the inlet receiver.

9. The emitter of claim 1, wherein the second diameter is smaller than the first diameter thereby creating a pressure loss when flowing from a smaller diameter of the second path portion to a larger diameter of the first path portion.

10. The emitter of claim 1, wherein the second diameter is oval in cross section.

11. The emitter of claim 1, wherein the base has a length of less than 1.0 inch.

12. The emitter of claim 1, wherein the emitter has a mesh limit of 120 to 40.

13. An emitter for use with a lateral to form an irrigation lateral, the lateral including a lateral wall having an inner surface and an outlet aperture, comprising:
a base having a top, a bottom, a first end, a second end, a first side, and a second side, the base including a pressure reducing portion, the top including an inlet receiver in fluid communication with a first portion of the pressure reducing portion, the bottom including an outlet bore in fluid communication with a last portion of the pressure reducing portion and the outlet aperture, at least a first intermediate portion interconnecting the first portion and the last portion, the portions of the pressure reducing portion being in fluid communication in series between the inlet receiver and the outlet bore to form a portion of an irrigation flow path, the first intermediate portion including a first vertical path portion interconnecting a first top path portion and a first bottom path portion, the first vertical path portion having a first vertical diameter, the first top path portion having a first top diameter, the first bottom path portion having a first bottom diameter, the first vertical diameter being smaller than the first top diameter and smaller than the first bottom diameter to create a first pressure loss when flowing through the pressure reducing portion, the bottom configured and arranged to operatively connect to the inner surface of the lateral wall.

14. The emitter of claim 13, further comprising a connecting portion interconnecting the first intermediate portion and a second intermediate portion, the second intermediate portion including a second vertical path portion interconnecting a second top path portion and a second bottom path portion, the second vertical path portion having a second vertical diameter, the second top path portion having a second top diameter, the second bottom path portion having a second bottom diameter, the second vertical diameter being smaller than the second top diameter and smaller than the second bottom diameter to create a second pressure loss when flowing through the pressure reducing portion, wherein the connecting portion interconnects one of the first and second top path portions or the first and second bottom path portions.

15. The emitter of claim 13, further comprising a cover configured and arranged to engage the top of the base, wherein the cover and the lateral along with their respective first top path portion and first bottom path portion form part of the irrigation flow path.

16. The emitter of claim 13, wherein the first vertical diameter is oval in cross section.

17. The emitter of claim 13, further comprising a diaphragm positioned between the inlet receiver and the outlet bore, wherein the diaphragm is configured and arranged to deflect when water flows through an inlet in fluid communication with the inlet receiver.

18. A combination emitter and lateral forming an irrigation lateral, comprising:
a lateral including a lateral wall having an inner surface and an outlet aperture;
an emitter having a base, the base having a top, a bottom, a first end, a second end, a first side, and a second side, the base including a pressure reducing portion, the top including an inlet receiver in fluid communication with a first portion of the pressure reducing portion, the bottom including an outlet bore in fluid communication with a last portion of the pressure reducing portion and the outlet aperture, at least one intermediate portion interconnecting the first portion and the last portion, the portions of the pressure reducing portion being in fluid communication in series between the inlet receiver and the outlet bore to form a portion of an irrigation flow path, each portion of the pressure reducing portion including a first path portion and a second path portion, the first path portion having a first diameter and the second path portion having a second diameter, the second diameter being different than the first diameter to create a pressure loss when flowing through the pressure reducing portion, the bottom configured and arranged to operatively connect to the inner surface of the lateral wall.

19. The combination of claim 18, wherein the first path portion of each portion of the pressure reducing portion is positioned proximate the top of the base and forms an opening in the top, further comprising a cover configured and arranged to engage the top of the base, the cover and the top forming part of the irrigation flow path, the cover including an inlet in fluid communication with the inlet receiver of the base.

20. The combination of claim 18, wherein the first path portion of each portion of the pressure reducing portion is positioned proximate the top of the base and forms a top opening in the top, further comprising a third path portion positioned proximate the bottom forming a bottom opening, the third path portion having a third diameter, the second diameter being different than the third diameter to create a pressure loss when flowing through the pressure reducing portion, wherein the second path portion vertically interconnects the first and third path portions, wherein at least one of the first and third path portions is interconnected to an adjacent portion with a connecting portion.

21. The combination of claim 18, wherein the second diameter is smaller than the first diameter thereby creating a pressure loss when flowing from a smaller diameter of the second path portion to a larger diameter of the first path portion.

22. The emitter of claim 18, wherein the second diameter is oval in cross section.
